(19) United States
(12) Patent Application Publication
(10) Pub. No.: US 2026/0036698 A1
(43) Pub. Date: Feb. 5, 2026

(54) ENVIRONMENTAL AWARENESS DISTRIBUTED SENSORS

(71) Applicant: VueReal Inc., Waterloo (CA)

(72) Inventor: Gholamreza CHAJI, Kitchener (CA)

(73) Assignee: VueReal Inc., Waterloo, ON (CA)

(21) Appl. No.: 18/996,159

(22) PCT Filed: Apr. 3, 2024
(86) PCT No.: PCT/CA2024/050424

§ 371 Date: Jan. 17, 2025

Related U.S. Application Data
(60) Provisional application No. 63/493,896, filed on Apr. 3, 2023.

(51) Int. Cl. G01S 17/931; G06V 10/70; G06V 20/58

(52) U.S. Cl. CPC G01S 17/931; G06V 10/70; G06V 20/58

(57) ABSTRACT

The present invention discloses methods and systems to create environmental awareness for objects or objects using sources and sensors. The sensors may be microdevices. The awareness is about the signals generated in a surrounding area of objects by detecting signals of various types emitted by sources. There may be more than one source and sensor in an object.

### BACKGROUND AND FIELD OF THE INVENTION

The invention relates to the addition of sources and sensors to objects to develop autonomy or other functions to provide environmental awareness.

### SUMMARY

The present invention relates to a method to create environmental awareness using multiple sources and sensors, the method comprising, having a mechanical structure that moves the source and sensors around to synchronize an area exposed by the source and detected by the sensor and generating a signal toward an area by the source, a reflected back signal from objects around is detected by the sensors and is used to detect a distance, a speed and related information.

The present invention release to a method to create environmental awareness using multiple sources and sensors, the method comprising, generating a random signal pattern by a source that generates a random signal pattern, detecting at least a part of the random signal pattern by the sensors and eliminating part of an entire pattern if the entire pattern is different, the sensor eliminating that part of the entire pattern.

The present invention relates to a method to create environmental awareness using sources and microsensors, the method comprising, having at least two micro sensors in a different part of an object, detecting differences in signal patterns with the microsensors; and eliminating interference.

The present invention relates to a method to create environmental awareness using sources and microsensors, the method comprising, having multiple sources with different wavelengths, detecting signals with microsensors associated with each source and extracting the signals from a combination of data from different microsensors.

### BRIEF DESCRIPTION OF THE DRAWINGS

The foregoing and other advantages of the disclosure will become apparent upon reading the following detailed description and upon reference to the drawings.

FIG. 1 objects with signal sources and sensors for environmental awareness.

FIG. 2 objects with signal sources and sensors for environmental awareness and setups to avoid interference.

The present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

The present disclosure describes methods and systems to create environmental awareness for an object or objects by using sources and sensors. The awareness may be in context of a threshold spherical area or radius with respect to the object or objects. Here, microdevices can be microLED, OLED, microsensors, MEMs, and any other type of devices.

Sources and microdevice sensors are added to objects to develop autonomy or other functions to provide environmental awareness. The sources may interfere with the other objects' detectors in the case of multiple objects in close proximity. Here care is used to demonstrate the invention and related embodiment, but this can be applied to other applications such as robotics and other transportation.

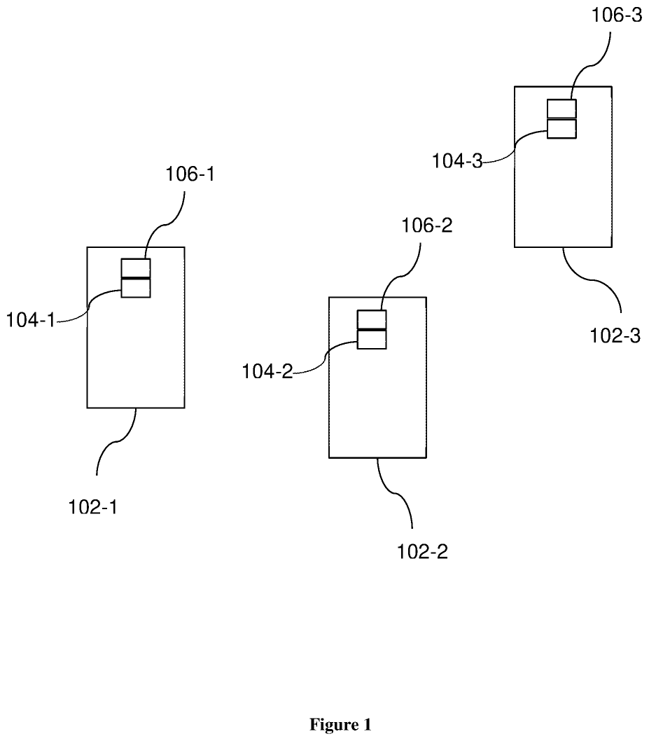

As shown in FIG. 1, one solution has been a mechanical structure that moves the source and detectors around to synchronize the area exposed by the source and detected by sensors. In this case, if another source exposes the same area, it will not cause much damage. The main issue is the bulky mechanical structure and reliability of the system. The car 102 (depicted by 102-1, 102-2, and 102-3) can have sensors 106 (depicted by 106-1, 106-2, and 106-3) and sources 104 (depicted by 104-1, 104-2, and 104-3). The source generates a signal toward an area, the reflected back signal from the objects around is detected by the sensors and is used to detect the distance, speed and other related information. In case there are multiple cars 102-1 102-2 and 102-3 moving closely, the signals can interfere. In one case the related information may be about physical dimensions, presence of physical structures in a threshold spherical area or radius, electromagnetic signatures or signals, olfactory and audible signals. This applies to all embodiments described below as well.

In one case, the source generates a random signal pattern. This will reduce the possibility of the other objects generating a similar pattern. If sensors detect that a part of the pattern in the entire pattern is different, the sensor can eliminate that part or the entire pattern. The pattern can be detected by the same sensor/detector or different sensor. The information is used to extract the reflection that is related to the source associated with the sensor.

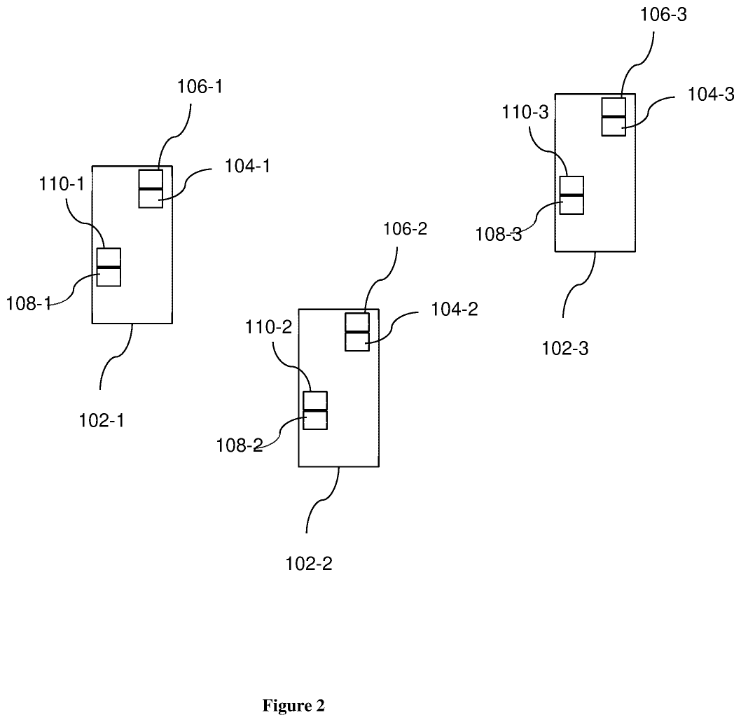

In one related to an embodiment to address the interference, as shown in FIG. 2, at least two detectors (sensors) (108-1, 108-2, 108-3) and (110-1, 110-2, 110-3) in a different part of the object are used. As a result, each sensor can detect the interference differently. This information can be used to eliminate the interference. Here the object can be related to automotive transport or robotics in nature.

In one related case, there can be more than two sources. Here, the cars 102 may have multiple sources 104 and multiple detectors/microsensors 106. The detectors/microsensors extract information from objects to the collective information that is used to extract the required data. In one related case, the sources are off and only detectors extract the information/data from the ambient or adjacent cars. In another related embodiment, the sources are turned on and off frequently, there are trails of images with and without sources. These trails of images are used in image processing and AI data to extract the information.

In one related embodiment, multiple sources with different wavelengths are used. The sources can be external (e.g. environment). Microsensors associated with each source are used to detect the source signals. The combination of data from different sensors associated with different sources can be used to extract the signals. For example, the data extracted for visible images can be used to highlight the areas that may have interference with Lidar signals.

In related embodiment to structures described here, the sensors are distributed at different areas of the object. In one related embodiment, the sensors are microsensors and laminated to the body of the object or between different layers in the body of the object. If different sensors are used, at least more than the type of sensors are used in close proximity in an object area. The sensors are distributed in different parts of the object and have different sight views. In one related embodiment, the sensors are shielded so they can detect interference differently.

In one related embodiment, the interference can saturate the detector, reducing the sensors' effectiveness in detecting the signals.

The present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

1. (canceled)

2. (canceled)

3. (canceled)

4. (canceled)

5. (canceled)

6. (canceled)

7. A method to create environmental awareness using sources and microsensors, the method comprising:
having at least two micro sensors in a different part of an object;
detecting differences in signal patterns with the microsensors; and
eliminating interference,
wherein the object is part of automotive transport or a robot and wherein the sources are off and only the microsensors extract the information from ambient or adjacent automotive transports.

8. (canceled)

9. The method of claim 7, wherein automotive transports as objects have multiple sources and multiple microsensors wherein further the microsensors extract information from objects to a collective information that is used to extract a required data.

10. (canceled)

11. (canceled)

12. (canceled)

13. (canceled)

14. A method to create environmental awareness using sources and microsensors, the method comprising:
having at least two microsensors in a different part of an object;
detecting differences in signal patterns with the microsensors; and
eliminating the interference,
wherein the object is part of automotive transport or a robot and wherein the sources are turned on and off frequently, and there are trails of images with and without the sources and wherein further the trails of images are used in image processing and AI data to extract the information.

15. The method of claim 14, wherein automotive transports as objects have multiple sources and multiple microsensors wherein further the microsensors extract information from objects to a collective information that is used to extract a required data.

16. The method of claim 14, wherein the sources are turned on and off frequently, and there are trails of images with and without the sources and wherein further the trails of images are used in image processing and AI data to extract the information.
